(19) United States
(12) Patent Application Publication
(10) Pub. No.: US 2013/0024165 A1
(43) Pub. Date: Jan. 24, 2013

(54) METHOD FOR DESIGNING STANDARDISED REPAIR KITS FOR AN AIRCRAFT FUSELAGE

(71) Applicants: Gilles Tardu, Toulouse (FR); Andre Galliot, Toulouse (FR)

(72) Inventors: Gilles Tardu, Toulouse (FR); Andre Galliot, Toulouse (FR)

(73) Assignees: AIRBUS, Blagnac (FR); AIRBUS OPERATIONS (S.A.S), Toulouse (FR)

(21) Appl. No.: 13/516,394

(22) PCT Filed: Dec. 14, 2010
(86) PCT No.: PCT/FR10/52712

§ 371 Date: Oct. 10, 2012

(30) Foreign Application Priority Data
Dec. 17, 2009 (FR) 0959118

(51) Int. Cl. G06F 17/50

(52) U.S. Cl. 703/1

(57) ABSTRACT

A method for designing repair kits for a predefined area of the external/internal structure of an aircraft, the repair kits each including an external/internal structural part having predefined shape and size, suitable for being placed within the existing external/internal structure, instead of an equivalent shape including a damaged area, which can be removed or not, the method including creating a range of standardised repair kits, optimized according to an estimate of the most likely types of accidental damage in the studied area.

The present invention relates to the field of aircraft structures. It relates more specifically to repairs to the skin and fuselage substructure in zones under severe threat of impact.

### Context of the Invention and Problems Addressed

Aircraft, for example of the commercial type operated by airlines, perform a great many turn-arounds between various airport platforms worldwide.

When they are being operated and, in particular although nonlimitingly, during the ground operations connected with their operation, accidental damage may be sustained by the external structure of the fuselage. Particular consideration is given here to damage of the mechanical knock type, caused by an object external to the aircraft. This may in particular be due to bird strikes or hailstones impinging on the fuselage during flight, or to knocks from vehicles connected with the airport ground operations (access stairways, baggage handling trucks and tractors, etc.).

Some of this damage is of no importance regarding aircraft safety (and counts as “allowable damage” that does not prevent the airplane from flying), whereas other damage prevents the craft from being returned to operation immediately. It is clear that, in this case, the loss of time to the airline operating the craft may run to hours, or even to days of the aircraft being grounded if the necessary parts are not available on the spot, and for the time it takes for the repair to be carried out in accordance with the relevant safety standards, thereby leading to a considerable operating loss before the craft is once again declared airworthy.

It will be understood that different actions therefore have to be taken according to the location, size and significance of the damage.

In current practice, type certification of a civil airplane assumes that the manufacturer of an aircraft has made a “repair manual” (also known as a “Structural Repair Manual” or SRM) available to its client companies. This repair manual contains values for allowable damage dependent on the type of damage, allowing the airline to put the airplane straight back into the air, and repair principles. Repair kits, which means the elements necessary for repairing a specific zone are available as part of the manufacturer's “spare parts” holdings, when the repairs are complex ones.

The repair manual indeed contains charts for determining what is known as the “allowable damage limits” beyond which the magnitude of the damage dictates a compulsory repair procedure. It may be that the standard repairs proposed do not, because of their limited size, fit the level of damage sustained. The same is true of certain zones of the structure (known as reserved zones or “restricted areas”) within which no standard solution is proposed, and in which any damage has to be dealt with through a special-purpose repair plan.

The repair manual is supposed to cover a wide variety of damage situations, which also becomes further enriched over time. Specifically, little by little it incorporates the most frequent instances of damage with which the airlines have been faced, or which they have reported.

When new airplanes enter service said extent to which the repair manual covers the damage is essentially and uniformly concerned with the commonplace zones, excluding certain “reserved zones” or certain excessive extents of damage.

For these reserved zones (generally zones which are structurally complex or cover critical equipment) or this damage of a magnitude in excess of a given threshold, the repair becomes a special-purpose one and has therefore to be analyzed on a case by case basis. In the instances known as non-SRM repairs, the repair solution defined is analyzed and justified by the aircraft manufacturer, which entails design-drawing and calculation activities as well as an approval-certification process. These activities are both lengthy and expensive, for the manufacturer who has to do the design-drawing, calculation and approval, but all the more so for the airline which has to face up to the fact that its operations are suspended (delays, cancellations, airplane grounded).

The repair manual is continually enriched by the manufacturer as the craft of a given model go through their life. Thus, a “non-SRM” repair may, over time, find its way into the repair manual if the repair plan is used repeatedly, at one and the same precise location and with the same size of replacement part used. Indeed a repair plan can never be inserted into the repair manual for the sole reason that the instances of damage encountered over the past history of the fleet has had slightly fluctuating dimensions or positions, especially if the zone is a complex zone and/or of evolutionary shape (e.g. nose cone). The repair manual is particularly well suited to instances of damage that systematically occur at the same place and in a similar way for the commonplace zones.

It is also clear that, in this procedure, only significant damage is notified to the manufacturer, who therefore practically never becomes aware of small sized instances of damage which are dealt with locally by the client companies through the repair manual.

It will be appreciated that such a procedure leads to many disadvantages, notably in terms of the length of the cycles involved in getting an approved repair solution in the case of special-purpose repairs, and also in terms of the uneven coverage of the repair manual.

### OBJECTIVES OF THE INVENTION

The objective of the present invention is therefore to overcome at least some of the abovementioned problems.

One of the objectives of the invention is thus to reduce the time for which craft is grounded during repairs of accidental damage sustained by the surface of these craft.

Another objective is to minimize the number of repair plans that the manufacturer has to produce during the whole life of the fleet (complex or otherwise zones).

Another objective is that of reducing the cost of the maintenance operations.

Other objectives of the invention are to envelop the most threatened zones of the fuselage and find, for these zones, remedies that involve making available as responsively as possible repair solutions (that will be termed “standard”) which in material terms are available in the form of repair kits.

For future airplanes with composite structures, shaping these materials is a trickier operation than it is on conventional airplanes involving aluminum sheet metal work. Having prefabricated repair kits available is an additional advantage over the shaping of the actual repair parts.

Finally, this principle can be extrapolated by incorporating the repair constraints into the very design of a new airplane (example: a doorframe bulkhead would, right from its design phase, incorporate a reserved zone so that it can be spliced).

### SUMMARY OF THE INVENTION

To this end, the invention relates to a method for designing repair kits for a predefined zone of an aircraft, said repair kits each comprising a part of predefined shape and size, designed to be installed within the existing structure, in place of an equivalent shape comprising an accidentally damaged zone, which may or may not be removed, comprising a step 400 of creating a range of standardized repair kits which is optimized according to an estimate of the most probable instances of accidental damage in the zone under consideration.

The novelty of the invention is that it anticipates the situation of instances of damage that are similar in terms of size and position and that it processes such a situation statistically. A range of repairs that is created more or less at random according to the instances of damage notified to the manufacturer and which strictly covers these instances of damage one by one is replaced by standard repairs, which are a little larger but which cover a statistically predetermined proportion of the instances of damage that may occur in a chosen zone of the craft (and that can also cover replacements of substructure—frames, stringers, internal linings, etc.).

It will be appreciated that the repairs cannot be shifted because they are situated in a specific zone (example: double curvature). The trick is to achieve this coverage by larger dimensions, the advantageous counterpart to this being that the solution is immediately available in the repair manual (SRM) and that kits will be available from stock. It is therefore possible to measure the favorable economic impact of this arrangement, in terms of the operating costs to the airlines.

According to one advantageous embodiment of the method, the method further comprises a step 100 of choosing a reference aircraft, equivalent to the aircraft under consideration, according to a predefined criterion notably taking account of the life of the aircraft expressed in number of flights, and which is possibly the same as the aircraft under consideration.

According to one advantageous embodiment of the method, it comprises, prior to the step of creating a range of repair kits, a step 300 of listing the representative accidental damage previously reported on the reference aircraft in the zone under consideration.

In this case, advantageously the step of listing the instances of accidental damage comprises a substep 310 of transferring a statistically significant number of instances of damage, which are identified in damage data sheets, onto a digital model of the aircraft zone under consideration.

It will be appreciated that the invention involves making available in the repair manual, and doing so as soon as the first airplanes of a fleet enter service, standard repairs, the outline of which is determined thanks to:

the extensive collection of data derived from the operation of the airplanes (damage description data sheets),
followed by a statistical analysis that makes it possible to determine the envelope of the zones under greatest threat,
and finally the insertion of said standard repairs into the repair manual.

According to one advantageous embodiment of the method, step 300 of listing the instances of damage further comprises a blocking-out substep 330 in which, for each instance of accidental damage, an associated “blocked-out zone” is represented which corresponds substantially to the zone which will have to be repaired during the maintenance operation, the shape of the outline of which blocked-out zone (rectangular, circular, etc.) is chosen according to the type of material of which the local structure of the aircraft is made. It will be appreciated that the repair does not necessarily involve replacing the damaged zone, particularly in the case of composite materials where bonded patched repairs are possible.

In this case, in one favorable embodiment of the method, one and the same blocked-out zone is associated with several instances of simultaneous accidental damage relating to one and the same damage data sheet if the distance between these instances of damage is less than a predetermined value, for example less than one inter-stringer distance and less than half the distance between fuselage frames.

According to one advantageous embodiment of the method, step 300 of listing the instances of damage further comprises a substep 320 of associating with at least some of the reported instances of accidental damage the plausible cause of each of these instances of damage.

In this case, advantageously, a cause is associated with a zone of accidental damage using statistical processing.

According to one advantageous embodiment of the method, step 300 of listing the instances of damage further comprises a substep 340 of extrapolating the accidental damage sustained by the reference aircraft to a new aircraft.

In this case, advantageously, during the step 340 of extrapolating the accidental damage to the aircraft under consideration, the outlines of the instances of damage and of the blocked-out zones are increased or reduced in size about their center, using a corrective factor characteristic of the relative sensitivity of the material of the skin and local characteristics of the structure.

According to one favorable embodiment of the method, the step 400 of creating the range of standardized kits comprises substeps:

410—of statistical analysis of the blocked-out zones associated with the instances of accidental damage transferred onto the digital model of the aircraft zone under consideration so that said instances of damage can be characterized in terms of size distribution and position of the blocked-out zones,
420—of creating and evaluating, according to a predefined criterion, several blocked-out zone overlap scenarios each associated with a predefined set of repair kit dimensions, and of choosing an overlap scenario that optimizes this criterion.

According to one advantageous embodiment, in this case, the results (mean and variability of the sizes and positions of the blocked-out zones) of statistical processing substep 410 are used to create a first overlap scenario by determining, according to at least one predefined criterion, the minimum size and minimum superposition of repair zones of preselected shape.

In this case advantageously, in substep 420, for each of the overlap scenarios created, a sensitivity study is performed by varying the size of the blocked-out zones, either proportionately or by varying only one of the dimensions at a time.

The invention is also aimed at a method for designing a new airplane, comprising a phase of defining zones of probable damage and a phase of proposing modifications to the structure in order notably to strengthen these zones and make them easier to maintain or keep critical equipment (such as aerological probes) away from them.

The invention is also aimed at an aircraft repair manual containing standardized repair solutions obtained using a method as set forth.

### BRIEF DESCRIPTION OF THE FIGURES

The description which will follow, which is given solely by way of example of one embodiment of the invention, is given with reference to the attached figures in which:

FIG. 1 illustrates, in two side views of a reference airplane fuselage, a series of impacts that have been recorded on airplanes of this model,

FIG. 2 illustrates the method for blocking out an actual impact,

FIG. 3 schematically illustrates, on an airplane fuselage seen in side view, three identified impact zones around an access door,

FIG. 4 likewise illustrates the impact probability zones identified on a given type of airplane,

FIG. 5 illustrates the principle of the 1st envisaged scenario, with ten rectangular repair kits,

FIG. 6 likewise illustrates the principle of the 2nd envisaged scenario, with twenty rectangular repair kits,

FIG. 7 illustrates the principle of the 1st envisaged scenario, with ten circular repair kits,

FIG. 8 illustrates the level of damage taken into consideration by the repair kits, depending on the scenario considered,

FIG. 9 illustrates a graph used for extrapolating the damage to a new airplane,

FIGS. 10a and 10b illustrate the principle of transferring blocked-out damage zones onto the digital model of a new airplane.

### DETAILED DESCRIPTION OF ONE EMBODIMENT OF THE INVENTION

The invention is intended to be used advantageously during the design phase of a new aircraft. However, it will be noted that it can also be implemented after this design phase, on an existing aircraft that has already entered service, in statistically significant number, by airline operators.

The method according to the invention may preferably be implemented, at least for some of its steps, in software form. Such software is then run on a computer of standard type, for example of the PC type, provided with memory-storage means, computation means and user and network interfaces all known per se. This computer is also assumed to be provided with the software tools that are commonplace in aircraft manufacturer design offices such as database administrator, computer aided design (CAD) software, statistical processing software, etc. It advantageously has network access with one or more servers hosting geometric information defining the design of the aircraft under consideration.

For the remainder of the description a longitudinal reference axis X of the airplane is defined, this corresponding substantially to its line of travel of the airplane. Likewise, a vertical axis Z is defined that corresponds to the local vertical.

The method is implemented, in this entirely nonlimiting example, for a new airplane in the process of being developed by a manufacturer.

The method envisaged is used to define in a rational manner the number and outline of repair kits associated with this new airplane, by contrast with the practices employed in the prior art as detailed above.

The description, given here by way of example, is restricted to the particular case of one zone of the fuselage of the new airplane under consideration, namely the area around the doors of the airplane, and to the instances of damage sustained in this zone caused by vehicles on the ground. This case is advantageous because it would seem that a great deal of low-intensity damage is recorded in this zone, making the method described particularly relevant.

The method of defining probable damage zones and suitable repair kits comprises several steps detailed hereinbelow:

### Step 100—Defining a Reference Airplane

To implement the method for the new airplane in the process of being developed by a manufacturer, said method begins with the defining of at least one “reference airplane” which is similar in terms of size, airports served, but above all life expectancy expressed in flight and type of mission performed. The number of turn-arounds per day performed by the airplane and the calendar life (of the order to 20 to 25 years) are key parameters in the choice of a reference airplane. For example, when developing a new long-haul airplane, the reference airplane from which experience is gleaned will be another long-haul airplane of a previous generation, as similar as possible according to the above criteria (notably but nonlimitingly including its size, airports served, and its life in terms of number of flights).

A reference airplane for a short-haul or medium-haul craft or more generally for any other craft, is chosen in the same way.

The reference airplane is, for example but not necessarily, chosen from the airplanes of the same manufacturer as the new airplane, out of ease of access to the maintenance data of the companies operating the airplane, or ease of access to the data from the design digital model of said reference airplane. What is known as a design digital model is a computer aided design file for the airplane, containing all the geometric and material dimensions that define the parts of the craft.

The method can be implemented on a new airplane at the start of operation, as soon as the number of reported incidents crosses a predetermined threshold, for example several tens in a given zone. Given that the “normal” level of damage for a short-haul craft making ten turn-arounds per day is generally taken to be one incident per year, the method can be implemented for example as soon as a fleet of twenty or so aircraft has been in operation for over one year.

### Step 200—Preparing the Simplified Digital Model

Starting with a digital model of the reference airplane, said digital model covering a given section relating to the zone under consideration, here the area around the doors of the airplane, the first task seeks to simplify the file of this digital model so that the simplified digital model contains only data used to characterize, in terms of size and in terms of position, damage to the aircraft skin. The data that have to be kept notably include:
exterior surface,
visible panel edges,
lines of fasteners between skin and substructures (stringer seams, frames, longitudinal and orbital joints, etc.),
edges of hatches, portholes and doors,
any other point of reference necessary for positioning the damage: aerological probes, antennas, etc.,
any material element that may serve as reference.

It is permissible to elect to adopt to keep a greater or lesser level of detail for the data in the simplified digital model, depending on the zones under consideration.

For example, because the remainder of the description relates to the area around the doors, the richness of the detail of the data kept in the simplified digital model can be adjusted in step 300 hereinbelow, to suit the requirements.

### Step 300—Mapping the Damaged Zones Most Frequently Threatened.

The method therefore makes use of the “experience” collected during operation of the reference airplane by the airlines which operate one or more examples of this reference airplane. This experience here takes the form of damage data sheets, created by each airline to describe damage logged on a craft, and stored in a suitable database (analog or digital). Each instance of damage is described in a report written by an airline operating one example of the reference airplane, and is confined to a database, each event being stored in the form of a damage data sheet. As may be appreciated, these are usually instances of damage that are outside the limits of the repair manual SRM, although enquiries conducted in the airlines allow exhaustive data (SRM+non-SRM data) to be collected over a more limited timeframe.

If the damage data relating to the reference airplane (taken from these damage data sheets) is considered insufficient in terms of number of data points (for example if there are fewer than a few hundred of them), they can be supplemented with damage data collected on another reference airplane, a little less close to the new airplane according to the choice criteria set out in step 100.

### 310—Transferring the Observed Damage

In this second step 300, the task consists, in a first substep 310, of transferring the damage data onto the simplified digital model of the reference airplane. What is meant by transferring onto the digital model is that the damage data reported by the airlines needs to be identified along the axes of the simplified digital model, in a way that is consistent with the scale of the airplane, and stored in this simplified digital model.

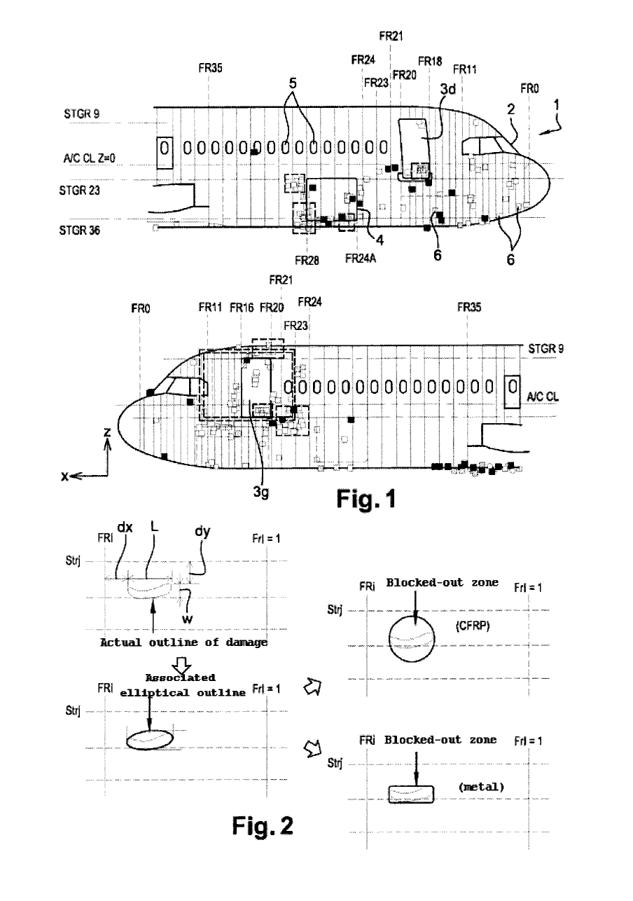

As has been indicated, the description here concentrates on damage situated in the area around the doors (FIG. 1); other instances of damage simply being counted up and represented, in the simplified digital model of the reference airplane, as a single point, so as to ensure that there are no other concentrations of damage, which are particularly well suited to the implementation of the present method.

In a more detailed manner, FIG. 1 illustrates the front end of an airplane fuselage 1, viewed from the two sides. Here it is an airplane of the short-haul passenger airplane type. This FIG. 1 shows some of the factors taken into consideration in a simplified digital model of the reference airplane. It shows the fuselage frames, here numbered from FR0 to FR35, the outlines of the windshield 2, of lateral doors 3g, 3d for passengers, of the baggage hold door 4, and of portholes 5. The damage, reported across all the aircraft in the fleet, has been represented here as small squares 6 positioned at the site of the impacts. The shade of gray of the fill of the squares symbolizes represents the various types of damage.

It may be noted that these instances of damage are highly localized: around the baggage hold door 4, at the bottom of the right-hand passenger door 3d, and even nearer the left-hand passenger door 3g. There, a great many instances of damage are logged near the bottom of the door, on the right-hand and left-hand lower edges of the door, above the door, and in the horizontal continuation of the door threshold, extending toward the cockpit. The other instances of damage appear, at first sight, to be distributed more randomly.

Some of these zones in which damage is concentrated appear to be predictable, whereas others on the other hand are more unexpected.

The characteristic attribute of this method is that it reveals statistically the impact zones that appear most frequently and the intensity of the impacts in these zones.

### 320—Analyzing the Plausible Causes of the Damage

The analysis of the plausible causes of the observed instances of damage on the basis of their location is outside of the scope of the method of defining probable damage zones and suitable repair kits as described in this entirely nonlimiting example.

However, it is clear that, for example, impacts near the bottom of the passenger door are most probably attributable to the placement of the passenger loading bridges, or “jetways”. Likewise, the metal structures that support flexible rain covers that can be deployed over these jetways may be responsible for the impacts near the top of the left-hand side door because they catch the wind as they deploy and retain ice that has built up overnight, as has been observed.

It is therefore possible in one alternative form of implementation of the invention, for a proportion of the logged instances of damage, in a substep 320 of this phase of transferring the damage to the simplified digital model, to assign to these instances of damage known causes which, for example, come from a predefined list of causes.

Such assigning may be done automatically, for example using an algorithm that analyzes by way of main component from a database instances of damage that are characterized by their position in an airplane frame of reference (for example a frame of reference connected with a passenger door corner), by their dimensions, by their type of shape and their intensity. Such an algorithm will highlight in one and the same cluster of points instances of damage that are of the same shape, energy and position, and probably can be attributed to the same cause, and will leave to one side instances of damage, possibly in the same zone of the airplane, but which are of a different shape or intensity (or any combination of these factors).

In such a case, knowledge of the cause makes it possible to determine how to extrapolate the position of the impact from the reference airplane to the new airplane.

Specifically, by way of explanatory example, the relative positioning, of an airport vehicle of fixed dimensions, with respect to a target point of contact (for example passenger door or cargo hold) statistically causes damage which are distant from this point of contact according to a probabilistic law of which the parameters (for example mean and standard deviation) are connected with the dimensions of the airport vehicle, but of which the position on the new airplane remains the same relative to the target point of contact (corner of the door for example).

In other words, for damage attributable to airport vehicles or facilities, it would seem that the position of this damage is then connected with the dimensions of the airport vehicles or facilities, which are to a large extent independent of the size of the airplanes they are serving.

By contrast, other instances of damage are directly connected to the size of the airplanes and, typically, to the size of their engines which dictate the routes followed by the vehicles to keep them away from these engines and from the wings.

Moreover, the intensity of an impact due to identified causes is then predictable, even though it does exhibit a certain variability.

A phase explaining the causes of at least a proportion of the instances of damage may therefore make it possible to improve how damage to a new airplane can be predicted.

However, the present description is concerned chiefly, in the present exemplary embodiment, with the statistical distribution of the positions of the instances of damage and with their characteristics, for example dimensions and intensity. The intensity of each instance of damage is therefore also transferred to the simplified digital model of the reference airplane.

This intensity is used, for example, to allow extrapolation from a metal airplane to an airplane, the fuselage of which is made of composite.

### 330—Blocking-Out the Damage

In a substep 330, for each instance of damage reported by an airline in a damage data sheet, its reported actual outline is first of all represented (FIG. 2), followed by its approximated outline, in the form of an ellipse, and an associated “blocked-out zone”. It will be appreciated that the blocked-out zone corresponds substantially to the zone which will have to be replaced during the repair operation required as a result of the damage.

The blocked-out zone is a first processing of the damaged zone. The outlines of the blocked-out zone are, in this example, parallel to the adjacent substructure elements (stringers and frames for example). However, the blocked-out zone may be chosen to be circular in shape (and this is desirable in the case of airplanes that use CFRP composite skins for bonded patch repairs), or any other shape that may be deemed suitable for the repair.

A blocked-out zone may encompass several instances of damage relating to one and the same file, that is to say which are associated with one and the same impact event, according to a simple criterion: if they are, for example, distant from one another by less than one inter-stringer distance and by less than half the distance between fuselage frames (or any other preselected distance threshold).

A total of several hundred elementary damage files should preferably be processed in this step 300 of transferring the damage. This number is deemed to be high enough to guarantee that the sample size thus created is significant, therefore allowing the statistical processing required in the synthesis step 400.

### 340—Extrapolating the Damage Zones to the New Airplane

The damage data created during this step 300 is then transferred onto the digital model of the new airplane during an extrapolation of the damage observed on the reference airplane to plausible damage to the new airplane. It will be noted that the digital model of the latter is therefore preferably developed using the same digital drawing software as the digital model of the reference airplane.

It is clear that extrapolation involves transferring onto the simplified digital model of the new airplane the damage that is listed for the reference airplane.

Consideration is given to the position and intensity of the damage (which is relevant in particular when extrapolating from an airplane with a metal skin to an airplane with a composite skin), to the local geometric characteristics of the skin and of the substructure, and to the cause of the damage if that has been identified in the phase of transferring the observed instances of damage.

In the case of damage around a door, the position of the damage is thus kept constant with respect to the threshold and to the front frame of the door, which then serves as fixed point of reference for the two digital models. This arrangement means that the target commonly used by an operator responsible for bringing a vehicle up close to the airplane during ground operations on an airport platform for example can be used as point of reference.

Finally, the outlines of the instances of damage and of the associated blocked-out zones can be increased in size about their center, using a predefined factor corresponding for example to a difference in skin material between the new airplane and the reference airplane, but also other local characteristics, for example geometric characteristics, of the impacted structure (thicknesses, distance to the frames, etc.). Corrective charts are devised in the model database and readjusted by testing on representative test specimens.

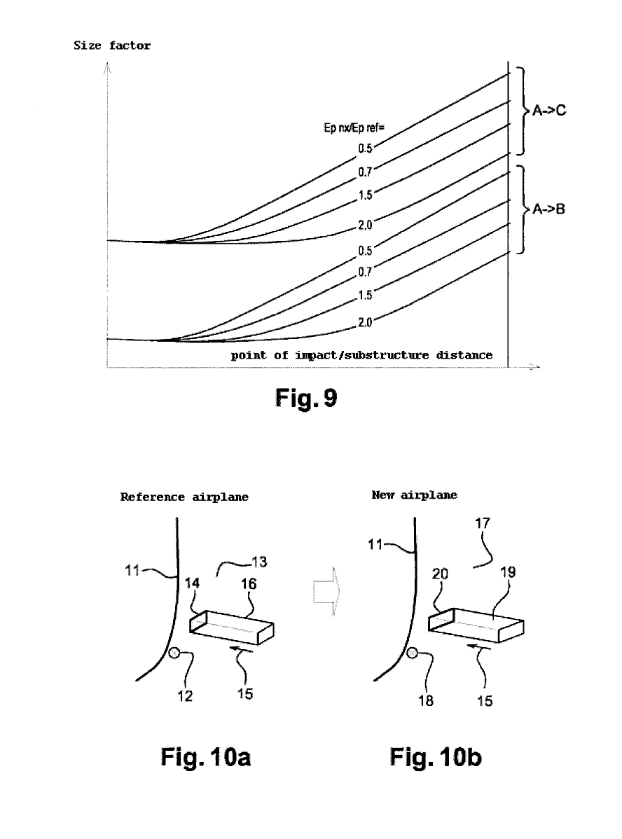

In this arrangement, an instance of damage (defined by its dimensions) detected on a reference airplane, that uses a first technology, is characterized by its impact intensity. Next, use of a precreated size correction chart and taking the local characteristics of the reference and new structure as input data makes it possible to determine the size correction factor for the blocked-out zone so that the instance of damage can be extrapolated to another structure with its intensity substantially unchanged. This then yields a new extent of damage for a new airplane, designed using a second technology. Such a chart can be created in a way know per se. One example of a chart is given by way of illustration in FIG. 9. This chart gives along the abscissa axis the distance of the point of impact with respect to the substructure and, along the ordinate axis, the factor to be applied to the dimensions of the instance of damage, with different variations in thickness of material, and switches from a first to a second type of material (represented by the cluster of curves marked A→C and A→B).

This arrangement thus allows a greater sensitivity of the skin material (for example of carbon fiber reinforced plastic or CFRP) to be taken into consideration.

In an alternative form, it is possible, during the extrapolation phase, to disregard any instances of damage seen on the reference airplane and that has been deemed on the damage data sheets to be “allowable damage”.

Alternatively, the instances of damage are all transferred onto the digital model of the new airplane and which instances of damage are allowable if calculated on this model, having awareness of the intensity of the damage and the nature of the local substructure (thicknesses, distance to the frames, materials, strengtheners). This allowable damage on the new airplane can then be excluded from the definition of the standard repairs.

It will be appreciated that the principles just mentioned are valid for extrapolating damage around a door of a reference airplane to a new airplane. It is clear that extrapolation principles may also be defined for other zones of the airplane (wing, engine nacelles, etc.) in a similar way.

The actual transfer onto the digital model of the new airplane is illustrated by FIGS. 10a and 10b. FIG. 10a (reference airplane) shows an outline 11 of an aircraft passenger door, a target 12 for docking a service vehicle, the external surface 13 of the reference airplane, a blocked-out region 14 corresponding to damage (with its size and position with respect to the target 12), the direction 15 of travel of the vehicle, and a so-called “extruded” volume 16 created from the blocked-out zone in the direction 15 of travel of the vehicle.

FIG. 10b likewise illustrates, but for a new airplane, the outline 11 of an aircraft passenger door corresponding to the same door of the reference airplane, a new target 18 for docking the service vehicle, the external surface 17 of the new airplane, and the direction 15, assumed to be identical, of travel of the vehicle.

The transfer therefore consists in recalculating the interception of the line of the damage in “extruded” form 19, corrected beforehand with the external surface 17 of the new airplane. It was seen above that this correction is performed using factors summarized in a chart and intended to take account of variations in material and local characteristics of the structure which differ. The axis of the damage in “extruded” form is parallel to the vector 15 of movement of the vehicle that caused the damage. From this it is possible to deduce the new blocked-out zone 20 for the damage on the new airplane, having the same position with respect to the docking target.

It will be understood that this step can be performed automatically, using a database.

At the end of this step 300 of transferring the damage across, the result is a map of the instances of damage observed on the chosen reference airplane and, by extrapolation, the map of the most plausible damage zones on the simplified digital model of the new airplane.

### Step 400—Synthesis on the New Airplane

This step of synthesizing the data on the digital model of the new airplane involves three substeps:

### 410—Statistical Processing in the “Blocked-Out Zones”

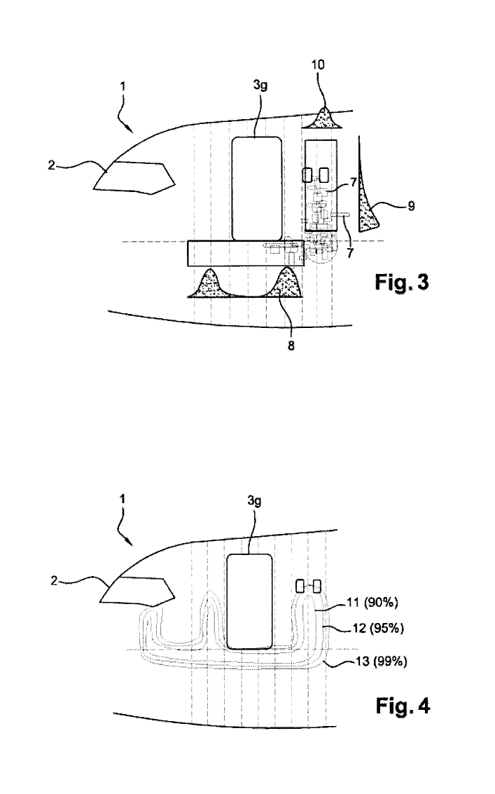

A statistical processing operation 410 (illustrated schematically by FIG. 3) makes it possible, first of all, to characterize the plausible instances of damage, as extrapolated onto the digital model of the new airplane (following the extrapolation performed in the previous step 300) in terms of size distribution and in terms of positions of the blocked-out zones.

This FIG. 3 again shows the airplane fuselage 1, viewed from the left, with the windshield 2 and a passenger lateral door 3g. The instances of damage concentrated around the door are indicated here in terms of their blocked-out zones 7. Profiles of statistical distribution laws in vertical and longitudinal directions are illustrated, both for the lower part of the door (curve 8) and for the vertical (curve 9) and longitudinal (curve 10) position profile.

### 420—Choosing a Distribution of Standard Repairs

The results obtained (means, variability) direct the second substep 420, by determining the minimum size and minimum superposition of the repair zones. Standard zones are defined, characterizing envelopes containing a given percentage of plausible damage, as shown by FIG. 4 which illustrates zones 11, 12, 13 respectively containing 90%, 95% and 99% of the probable instances of damage around the door of the new airplane under consideration.

The content of each zone is also characterized. This characterizing involves first of all ensuring the statistical homogeneity of the zone, the variability both on the positions and sizes of the instances of damage and on the intensities of impact, as well as on the natures and causes of the damage.

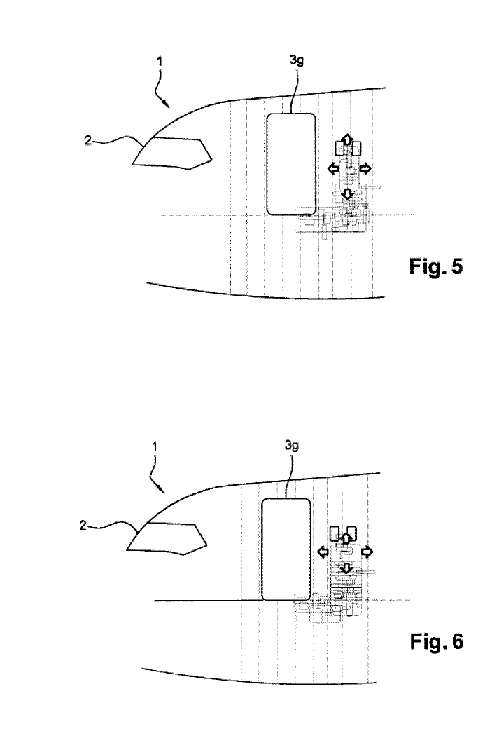

During this second substep 420 of synthesis several repair distribution scenarios (here repair means the replacement part for a zone of the airplane skin, possibly including part of the substructure) are created. In this nonlimiting example, two scenarios (FIGS. 5 and 6) are envisaged. The first scenario (FIG. 5) has a dense distribution of small repairs and the second scenario (FIG. 6) has a low number of large repairs.

In point of fact, by adopting a set of large repairs it is possible to reduce the risk of not being able to cover extensive damage, the counterpart to this being that the size of the repair is out of proportion with the extent of the damage in the majority of situations. In the reverse case, of standard small repairs but in great number, there is the risk of not being able to cover a certain number of instances of particularly extensive damage, but the typical repair size remains closer to the average size of the damage. In order to resolve this contradiction it is important to characterize the mean size of the instances of damage, their variability, two extreme cases are considered and, at the end of the analysis, the relevance (for example in terms of cost) of each of the 2 options will be evaluated.

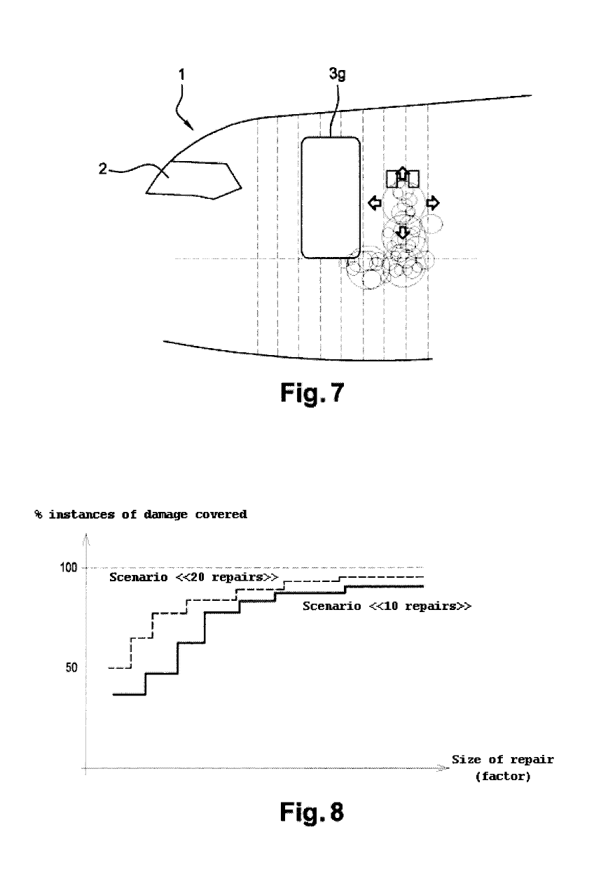

As may be seen from FIG. 7, repairs of circular shape for bonded patched repairs (corresponding for example to the case of composite skin materials) are also considered during this stage of the study.

For each of the two scenarios, a sensitivity study (FIG. 8) is conducted, varying the size of the blocked-out zones either proportionally or by varying in just one of the dimensions at a time.

This study makes it possible to determine in what proportion damage can be repaired with a set of ten standard repairs or with a set of twenty standard repairs, depending on the mean size of the repairs.

It will be appreciated that this sensitivity study is of a conventional type and is carried out using a technique known to those skilled in the art.

It is absolutely essential at this stage to give consideration to the specifics of the substructure of the new aircraft being designed, around the doors (doorframe bulkheads), and to the constraints on overlap between repairs. Specifically, the size and overlap of the standard repairs need to provide the best possible chance of covering the majority of instances encountered, for optimal overall cost reasons.

Each proposed repair is characterized by the proportion of extrapolated plausible instances of damage that it covers and so the issue is one of optimizing the contradictory factors “additional cost of a large-sized repair as compared with the additional cost of the proportion of instances not covered” giving due consideration to all the cost factors (inspections, carrying out the work, materials, cancellations, delays, airplanes grounded).

### 430—Schematic Drawings for the Repairs

Finally, once an optimum distribution has been defined against a predefined criterion, for example in terms of the number of standard repairs required, schematic drawings for the repairs are produced in a substep 430. The threshold and the bulkhead frames are taken into consideration during this drawing substep 430, because of the impact they have in terms of constraints on the repairing of the skins, but the repair of them themselves is outside the scope of the present invention.

### ADVANTAGES OF THE INVENTION

One major advantage of the invention stands out by comparing the prior art with the method according to the invention. Indeed, one shortcoming of the method used in the prior art is that zones that statistically are very highly exposed, such as the area around the doors (passenger doors, service doors, cargo doors) are insufficiently covered, which leads to a considerable economic impact on airlines and insurance companies.

An economic analysis recently performed on this subject has estimated the cost of repairs over the lifecycle of a fuselage front section of a short-haul aircraft (performing many turn-arounds per day) at several million dollars. A large proportion of this sum is from repairs not covered by the repair manual, and is the result of airplanes being grounded.

By contrast, it is possible, on a given fleet of airplanes (short-haul airplanes) to evaluate the saving afforded by a method according to the invention, in terms of the reduction in the mean length of time the plane remains grounded and the costs associated therewith.

Delivery of an available repair kit (taken from the repair manual) currently takes between 12 h (small packages by express courier) and 72 h (large kits which nonetheless fit into a van).

Moreover, for special-purpose repairs not covered by the repair manual, a permanent repair requiring a complete cycle (design, calculation, approval and manufacture of the parts) represents a lead time of one to two months, but a temporary repair is then fitted to the damaged zone so that the airplane is not grounded for the full two months. This temporary repair has a cycle time of one week.

The difference in length of time of grounding is therefore of the order of five days per repair, but quite often in the case of the corners of the door, the repair is so complicated that it already falls into the permanent-repair category.

Knowing that the mean number of repairs, in the zones under heavy threat such as the corners of the door, is estimated at 20-25 over an airplane lifecycle (short-haul airplane making ten turn-arounds per day) which amounts to approximately one repair per year, preventing the airplane from being operated for five days, the saving made by the airline on each aircraft may exceed one million euros over the life of the craft.

To this saving should be added the saving achieved by the manufacturers, which amounts to a comparable sum. Indeed, through the very principle of making all-encompassing repairs, each covering a considerable number of situations at whole-fleet level, the total number of repairs that have to be drawn out, calculated and approved can be reduced. The workload on the departments tasked with drawing the repairs and interfacing with the airlines can be reduced correspondingly.

Another advantage of the method as described is that, in a situation involving damage around the doors for example, the airline operating the aircraft is no longer forced to turn to the manufacturer. It thus avoids having to go through a long process of exchange of correspondence (in order to determine, and then confirm, the extent of the damage), of drawing up the plan, of calculating the repair and finally of having the latter approved, because a solution then exists in the repair manual.

Repair kits are also made available and enable a determined fraction of the instances that will be encountered across the life of the airplane to be covered.

In general, it is commonly estimated that around 80% of the damage sustained by an airplane is covered by the repair manual (SRM). However, the cost incurred by the remaining 20% turns out to be far higher than the cost of the other 80% because the airplanes are grounded for lengthy periods of time. It is therefore desirable for the greatest possible number of instances of damage to be covered by the repair manual, as these repairs can then be organized by the operating airlines.

Implementing this method also avoids having to make the repair twice (the temporary repair that allows the airplane to return to service until its scheduled downtime—for major inspection for example—followed by the permanent repair).

The repair can be renewed a number of times over (extending to a larger size of repair and/or a greater fastener diameter) if the same zone is impacted a number of times over during the lifecycle of the airplane. Use may then potentially be made of “nested” repairs, the one encompassing the other.

Finally, the data and analysis carried out on a reference airplane exhibiting similar operating conditions (number of turn-arounds per life) but having a metal skin can be exploited for an airplane with a fuselage made of composite material (or vice versa) provided that the damage is extrapolated giving due consideration to the difference in behavior of the materials for identical impact conditions: the effect the material has on the dimensions and nature of the damage.

The standard repair can be significantly more extensive than is the damage, and it may take slightly longer (for example an hour or two) to carry out, but this additional time remains of secondary importance with respect to the fact that there is no need for the airplane to be grounded for as long as it has to be grounded in the prior art (for several days, or even a week).

### Alternative Forms of the Invention

The scope of the present invention is not restricted to the details of the embodiments considered hereinabove by way of example but on the contrary extends to modifications that are within the competence of the person skilled in the art.

As has already been mentioned, the rational anticipation approach involved in the method according to the invention, set forth for the case of a new airplane under development, can also be used for the logistic support of an airplane already in operation. In such a case there is no need for the extrapolation phase mentioned in substep 340.

The process described can lead to a number of strategies:

1/ choice of small repairs with numerous overlaps,
2/ choice of large repairs with moderate overlaps,
3/ a combination of both.

It is in fact an in depth statistical awareness of the magnitude of the damage, and the constraints imposed by the substructure and its partial replacement that will then determine what is the best strategy. It is also possible to work on two scales, with both families of repair size if a statistical analysis reveals a great deal of variability in damage size.

In an alternative form of embodiment of the invention, phase 300 of transferring the damage also involves a substep of statistically analyzing the damage zones identified on the reference airplane and transferred onto the simplified digital model thereof. The purpose of such an analysis is to attribute the instances of damage automatically to predefined causes. For example, such a statistical analysis, of a type known per se, may reveal damage zones which are approximately the width of a jetway apart.

In such a case, the extrapolated damage zones will remain that same distance apart on the new airplane, irrespective of its own dimensions. By contrast, damage connected with the opening of the passenger door itself, has a probable zone of a size that is proportional to the size of this door on the new airplane.

In another alternative form of implementation of the method according to the invention, this method includes a step 500 of proposing modifications to the structure of the airplane when the airplane is in the development phase. This alternative form is conceivable when the method of defining probable damage zones is incorporated into the design method for designing a new airplane.

For implementing the method of determining the probable damage zones modifications to the structures of the airplane can then be deduced so that in particular these zones can be strengthened, their maintenance made easier, for example by ensuring that a repair can perhaps be incorporated into a zone of a smaller size, or by keeping critical equipment away from the zones under threat. In other words, steps are taken right from the design of the airplane to ensure that the airplane is strengthened at those points where it will very probably be struck, and to make it easy to repair at these points.

This arrangement then makes it possible to reduce the extent of damage likely to occur to allowable damage thanks to the localized reinforcing of the structure. The allowable damage is determined by the fact that with this damage present the residual strength of the structure remains acceptable (a requirement for certification). Of course, the greater the intensity of the impact, the higher are the risks at a given point on the structure that these allowable limits will be exceeded and that an on-the-spot repair will become necessary. The issue this time is that of improving the robustness of the structure by ensuring, when it is being engineered, that the damage remains within the allowable limits: for a given intensity it is possible to heighten the strength of the structure at certain points when damage occurs to ensure that the damage remains within the allowable limits, which means to say can, if left as it is, withstand the intended loading levels.

An embodiment of the method has been described with respect to repairs to the skin of the aircraft. Nonetheless, it remains clear that a similar method can be put in place more generally for repairs carried out deeper within the structure of the aircraft, or even for anticipating corrosion damage.

1-11. (canceled)

12. A method for designing repair kits for a predefined zone of an aircraft under consideration, the repair kits each comprising a part of predefined shape and size, configured to be installed within the existing structure, in place of an equivalent part comprising an accidentally damaged zone, which may or may not be removed, the method comprising:
choosing a reference aircraft, equivalent to the aircraft under consideration, according to a predefined criterion taking account of a life of the aircraft expressed in number of flights or number of hours, and which may be a same as the aircraft under consideration;
listing representative accidental damage previously reported on the reference aircraft in the zone under consideration; and
creating a range of standardized repair kits which is optimized according to an estimate of most probable instances of accidental damage in the zone under consideration.

13. The method as claimed in claim 12, wherein the listing the accidental damage comprises transferring a statistically significant number of instances of damage, which are identified in damage data sheets, onto a digital model of the aircraft zone under consideration.

14. The method as claimed in claim 13, further comprising a blocking-out in which, for each instance of accidental damage, an associated blocked-out zone is represented that corresponds substantially to the zone that will have to be repaired during the maintenance operation, and a shape of the outline of which blocked-out zone is chosen according to a type of material of which the local structure of the aircraft is made.

15. The method as claimed in claim 14, wherein one and a same blocked-out zone is associated with plural instances of accidental damage relating to one and a same damage data sheet if the distance between these instances of damage is less than a predetermined value, or is less than one inter-stringer distance and less than half the distance between fuselage frames.

16. The method as claimed in claim 13, further comprising associating with at least some of the reported instances of accidental damage a plausible cause of each of these instances of damage.

17. The method as claimed in claim 16, wherein, in the associating, a cause is associated with a zone of accidental damage using statistical processing.

18. The method as claimed in claim 13, further comprising extrapolating the accidental damage sustained by the reference aircraft to a new aircraft.

19. The method as claimed in claim 18, wherein, during the extrapolating the accidental damage to the aircraft under consideration, outlines of the instances of damage and of the blocked-out zones are increased in size about their center, using a corrective factor characteristic of relative sensitivity of a material of a skin.

20. The method as claimed in claim 14, wherein the creating the range of standardized kits comprises:
statistical analysis of the blocked-out zones associated with the instances of accidental damage transferred onto the digital model of the aircraft zone under consideration so that the instances of damage can be characterized in terms of size distribution and positions of the blocked-out zones; and
creating and evaluating, according to a predefined criterion, plural blocked-out zone overlap scenarios each associated with a predefined set of repair kit dimensions, and choosing an overlap scenario that optimizes this criterion.

21. The method as claimed in claim 20, wherein the results of the statistical analysis are used to create a first overlap scenario by determining, according to at least one predefined criterion, a minimum size and minimum superposition of repair zones of preselected shape.

22. The method as claimed in claim 21, wherein in the creating and evaluating, for each of the overlap scenarios created, a sensitivity study is performed by varying a size of the blocked-out zones, either proportionately or by varying only one of dimensions at a time.
